(19) United States
(12) Patent Application Publication
(10) Pub. No.: US 2021/0239479 A1
(43) Pub. Date: Aug. 5, 2021

(54) Predicted Destination by User Behavior Learning

(71) Applicant: Bayerische Motoren Werke Aktiengesellschaft, Muenchen (DE)

(72) Inventors: Wangsu HU, Chicago, IL (US); Jilei TIAN, Chicago, IL (US)

(21) Appl. No.: 16/776,617

(22) Filed: Jan. 30, 2020

(51) Int. Cl. G01C 21/34; G06N 5/04; G05B 13/02; G01C 21/32; G01C 21/36; B60H 1/00

(52) U.S. Cl. CPC G01C 21/3484; G06N 5/04; G05B 13/0265; B60H 1/00971; G01C 21/3492; G01C 21/3667; G01C 21/32

(57) ABSTRACT

A system, method and non-transitory computer-readable medium for predicting a trip destination of a user based on user behavior learning are provided. Historical behaviors and a target behavior of the user are received from a feature processing layer, and the received historical behaviors and the target behavior are embedded with features including a time and a location to produce a context modeling layer. A user modeling layer is produced by embedding the context modeling layer. A trip destination is predicted based on historical trip data and target trip data in the user modeling layer.

### BACKGROUND AND SUMMARY OF THE INVENTION

The present invention relates to a system, method and non-transitory computer-readable medium for predicting a destination of a user based on user behavior learning.

Being able to predict a destination of a user in a vehicle, e.g. smart navigation and notification for route information, is an important aspect of vehicle and mobile device applications for providing services to users. The destination can be predicted well by learning user behavior.

The recommender engine of an industrial prediction system usually requires a variety of models to extract different aspects of both user demographics and context features. User demographics contain information such as gender, income, affordance, category preference, etc., all from the user behaviors, trying to capture both long-term and short-term user interests. Meanwhile, context features are normally represented by the temporal and spatial information such as when and where a user takes an action. Then it builds different models for each recommendation scenario using those extracted features, either continuous or categorical. These are multi-step tasks and it is difficult to optimize them jointly.

Since user trip data is a sequence of visited locations ordered by timestamps, a Recurrent Neural Network (RNN) is commonly applied to model user behaviors. RNN is a class of deep learning network that consists of a directed graph along a temporal sequence. Such architecture enables dynamic behavior modeling of the sequential data input such as trip data, but the process is slow and hardly runs in parallel.

In contextual and personal services such as predicted trip destination, it is expected to model the context, e.g. temporal and spatial information, to model user behavior, and then build a predicted model. The present invention provides a low-complexity algorithmic framework for destination prediction based on user mobility behavior learning aiming to enable scalable service. The framework can capture and extend user behavior from other areas too.

RNN is the most commonly used sequence modeling through encoding user behaviors through a temporal sequential order. However, RNN has a number of disadvantages. First, RNN is hard to parallelize in the prediction phase, which is a problem for scalable service requiring fast processing time upon extensive requests from clients. Second, the RNN embedding of the user behaviors is a fixed-sized, aggregated status, which is not well suited for modeling both long and short behavior sequences. RNN can easily fail to preserve specific behavior information when used in downstream applications.

Regarding context modeling, the context information is normally processed into a key-value pair first such as (‘weather’: ‘sunny’) or (day of ‘week’: ‘Monday’) and then converted into categorical variables. Although such modeling can support targeted downstream tasks with a rule-based approach, it is very difficult to quantitatively analyze the context feature itself in the statistical modeling approach due to the discrete value of data. Therefore, the learned features are hardly reusable in other applications.

Regarding the representation learning method, the attention-based frameworks are proposed, e.g., “ATRank” for online purchase recommendation system. The result shows potential of adapting it to predicted destination. See, e.g., https://arxiv.org/pdf/1711.06632.pdf. However, there are problems associated with this framework. Unless the order of user behavior is invariable, the collection of sequential data makes the computation very time-consuming, especially toward a large-scale periodically-updated data feed in commercial service. Also, the temporal information only contains the relative timestamp to now, hence the corresponding contextual information is not fully leveraged.

In the present invention, we provide an advanced algorithmic framework for predicted destination that aims to, given certain contextual information, predict the most possible destination considering both downstream performance and algorithm scalability. This framework has low complexity while modeling rich semantics of both context and content information recorded along user trip history.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a schematic block diagram of an exemplary embodiment of a system according to the present invention.

FIG. 2 illustrates an exemplary embodiment of a method according to the present invention.

FIG. 3 illustrates an exemplary embodiment of user behavior learning for a predicted destination based on historical data.

FIG. 4 illustrates a high level representation of the algorithmic framework according to the present invention.

FIG. 5 illustrates an exemplary embodiment of behavior embedding for a trip according to the present invention.

### DETAILED DESCRIPTION OF THE DRAWINGS

An objective of the present invention is to provide a predicted destination to a user for any given time and any departure location whenever it is requested by the user. According to exemplary embodiments of the present invention, the algorithmic framework can be used to provide a time-to-leave that reminds a user to leave at the right time due to real time traffic change, smart preconditioning that reminds the user to precondition a vehicle or automatically precondition the vehicle before the trip (e.g., heating/cooling), and smart search and navigation in which one or more destinations are recommend to the user when the user starts to drive based on the user's context.

At a high level, the system processes the data into features organized by a feature processing layer, a context modeling layer, a user modeling layer, and similarity measurement layers. The system is trainable based on the loss (error) defined by a prediction task, e.g., a predicted destination.

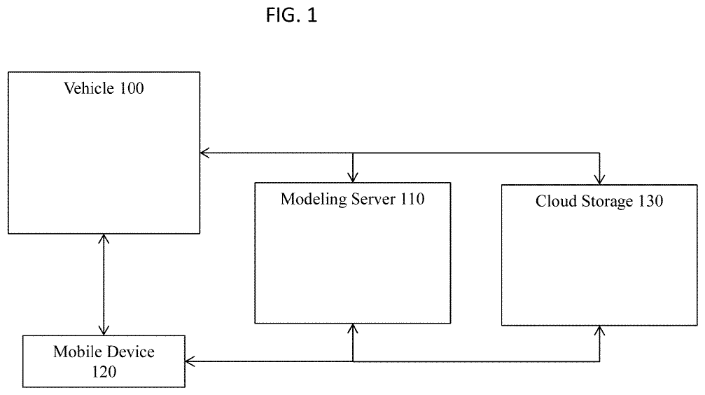

FIG. 1 illustrates a schematic block diagram of a system according to an exemplary embodiment of the present invention. The system may include, for example, a vehicle 100, a modeling server 110, a mobile device 120, and cloud storage 130. Each of these devices has its own processor and memory and a communication interface(s), wherein the processors are specifically programmed to perform the functions described herein. Telemetry data and the like may be received from the vehicle 100 and may be received from the mobile device 120. The mobile device 120 may be a smart phone, tablet computer or the like. Communication between the modeling server and the vehicle/mobile device may occur via cellular network, WiFi, Bluetooth, or the like. Data gathered from the vehicle 100 and the mobile device 120 may be transmitted to the modeling server 110 or transmitted directly to cloud storage 130.

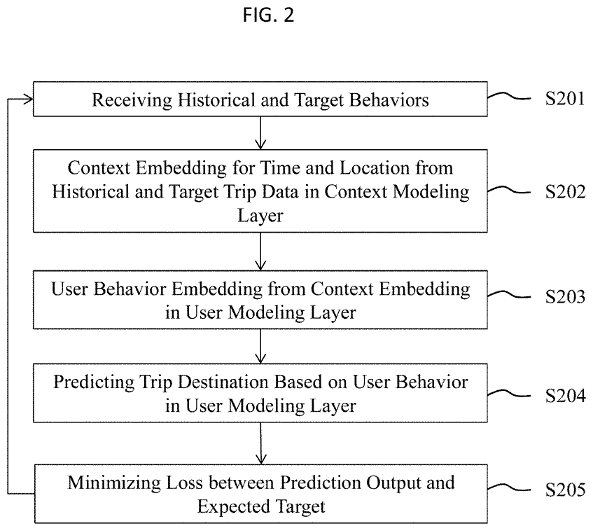

FIG. 2 illustrates an exemplary embodiment of a method according to the present invention. In step S201, historical and target behaviors of a user are received from a feature processing layer. In step S202, context embedding for time (e.g., day of week, hour of day) and location from the received historical and target trip data is performed to produce a context modeling layer. In step S203, user behavior embedding is performed on the received context modeling layer to produce a user modeling layer. In step S204, a trip destination is predicted based on user behavior in the user modeling layer, which produces a similarity measurement layer including a probability of the predicted destination being the trip destination. In step S205, the output is compared to the ground truth of the actual destination reached by the user to produce a loss (error), which can be used to minimize the loss and improve the next prediction. During an initial learning phase, the processes may be repeated any desired number of times in order to produce an output with a desired level of accuracy.

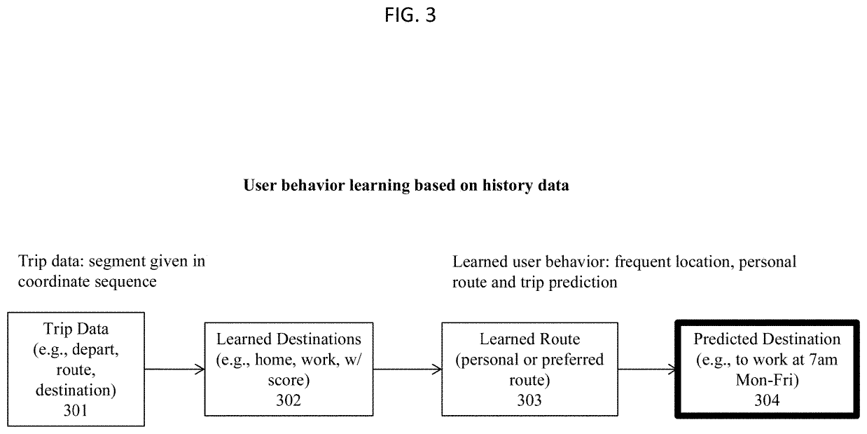

FIG. 3 illustrates an exemplary embodiment of a user behavior learning process according to the present invention. Based on the trip data (e.g., departure times, routes, and destinations) obtained in step 301, destinations of the user are learned in step 302 (e.g., home, work, school, restaurant) and a score is assigned to each destination based on frequency of use or the like. In step 303, the user's routes are learned (e.g., personal, business, preferred routes) based on the learned destinations. Then, a predicted destination of the user can be determined in step 304 based on the learned routes, learned destination, and trip data of the user. The learned routes and destinations for the user are stored in a memory that is accessed by the system

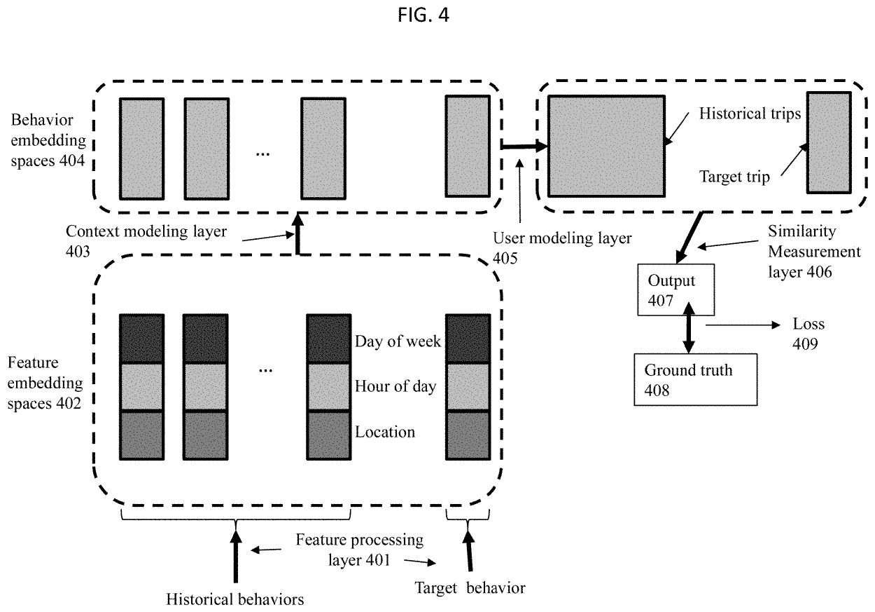

As illustrated in FIG. 4, a feature processing layer 401 including historical behaviors and a target behavior are input to a feature embedding process 402 that includes day of the week, hour of day, and location. From this processing, a context modeling layer 403 is produced that is used for behavior embedding 404 to produce a user modeling layer 405. A similarity measurement layer 406 is produced based on the user modeling layer and the historical trips and target trip information. The output 407 of this process is compared to the ground truth 408 or actual destination to determine a loss (error) 409 between the target and actual destination.

The feature processing layer is further described below. A user trip is defined as visiting a certain location at a given temporal context. All visited locations L and temporal context C are modeled to construct the feature processing layer consisting of the raw input. Here, we further decomposed temporal context C into two features: day of week D and hour of day H.

In order to encode spatial and temporal information, representation learning is applied to generate an “embedding” vector for different objects. An embedding is a mapping of a discrete categorical variable to a vector of continuous numbers. Therefore, the semantic meaning can be enriched for objects such as locations, hour of day, and day of week. Normally, embedding can be trained in a data-driven framework to preserve the semantic meaning of objects. Here we embed features of location set L, day of week set D, and hour of day set H as follows:

E({L})=[[L_{1,1}, L_{1,2}, . . . , L_{1,S}], . . . , [L_{Q,1}, L_{Q,2}, . . . , L_{Q,S}]]

E({D})=[[D_{1,1}, D_{1,2}, . . . , D_{1,S}], . . . , [D_{7,1}, D_{7,2}, . . . , D_{7,S}]]

E({H})=[[H_{1,1}, H_{1,2}, . . . , H_{1,S}], . . . , [H_{24,1}, H_{24,2}, . . . , H_{24,S}]]

where S is the pre-defined feature size of embedding vector and Q is the size of locations.

Therefore, we can encode any trip (l, d, h) in which the user visited the l-th location on the d-th day of the week at the h-th hour of the day.

E(l, d, h)=(lookupₗE ({L}), lookup_{d}E ({D}), lookupₕE({H}))

where lookupᵢ(E) is an operation that extracts the i-th row from the embedding matrix E, and the extracted vector is of (S, 1)-size.

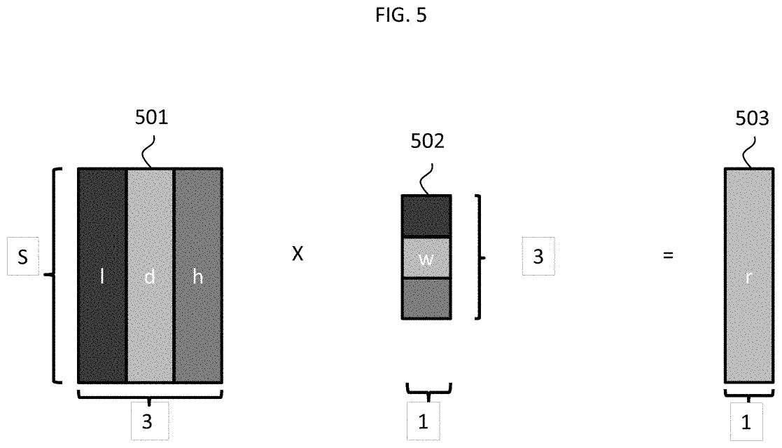

In the context modeling layer, our goal is, given processed contextual information E(l, d, h) of trip r, to construct its semantic embedding. We let Eᵢ=lookupᵢ(E) represent the lookup i-th row operation for embedding matrix E, and l, d, h be the lookup index of location, day of week, and hour of day, respectively. Here we introduced the proposed embedding modeling as shown in FIG. 5. In FIG. 5, element 501 represents an (S, 3)-size matrix of trip data (l, d, h) in which the user visited the l-th location on the d-th day of the week at the h-th hour of the day. Element 502 represents a (3, 1)-size vector for behavior embedding, and element 503 represents the behavior embedding for trip r.

The detailed calculation of the behavior embedding for trip r is as follows:

r=(concatenateₐₓᵢₛ₌₁(E(Lₗ),E(D_{d}),E(Hₕ))×w+b)

where concatenateₐₓᵢₛ₌₁( ) is an operation that concatenates the three (S, 1)-size vectors along the second axis to generate an (S, 3)-size matrix, and w and b are linear transformation parameters that need to be trained.

The user modeling layer is further described below. Given the user's trip record r through context modeling, we have user trip sequence R_{seq} that consists of a sequence of user trip data ordered by timestamps. Our target is to learn the temporal pattern and regularity from the context data embedded in the feature, e.g. day of week and time of day, rather sequence order by time. Thus, we are able to precompute the user behavior offline, and reuse it for prediction purposes, which reduces the memory and computation cost.

Assuming the user has T number of trips, we concatenate all r along axis t to generate an (S, T)-size matrix, i.e., R_{seq}=(r₁r₂ . . . r_{T})ₜ. R_{seq} requires a sequential data collection due to the nature of the permutation variance. For example, (r₁r₂ . . . )ₜ≠(r₂r₁ . . . )ₜ as we swap any two position of behavior records.

Unlike conventional sequential modeling methods, we give all possible permutations to the network such that it learns a pattern to be permutation invariant as f (r₁r₂ . . . r_{T})=f(pi(r₁r₂ . . . r_{T})) for any permutation pi, which reduces computation cost. In practice, such learning can be done through the proposed attention-based network and completely offline. Therefore, the user trip history Rₕᵢₛₜ can be generated as a set of given all permutations using elements of R_{seq}, i.e., Rₕᵢₛₜ={pi (R_{seq})} where pi represents all possible permutations. In practice, this operation can be simplified through shuffling.

Meanwhile, we modeled the target trip in a similar way as the trip record r. The contextual information of the target trip went through all the aforementioned layers to generate a target trip r_{tgt}.

r_{tgt}=(concatenateₐₓᵢₛ₌₁(E(Lₗ),E(D_{d}),E(Hₕ))×w+b)

Given the user trip history Rₕᵢₛₜ that is (S, T)-size, we can apply a self-attention-mechanism based network, such as the one developed by Google in 2017 (https://arxiv.org/abs/1706.03762) to model the user embedding U. Self-attention is an attention mechanism relating different positions of a single sequence in order to compute a representation of the sequence. The calculation of user embedding U is simplified as follows.

$$f ( Q , {K}_{i} ) = {Q}^{T} {K}_{i}$$

$${a}_{i} = softmax ( f ( Q , {K}_{i} ) ) = \frac{exp ( f ( Q , {K}_{i} ) )}{{\sum }_{j} exp ( f ( Q , {K}_{j} ) )}$$

$$U = {\sum }_{i} {a}_{i} {V}_{i}$$

where Q, K, V represents the query, key, and value, respectively, which are concepts used in the attention mechanism. Here Q=K=V=Rₕᵢₛₜ. After calculation, the output is an (S, T)-size matrix that represents personal embedding based on the user's trip history.

The similarity measurement layer is further described below. Given the model user embedding U and target trip embedding r_{tgt}, we can use two simple one-dense-layer neural networks to map two embeddings into common semantic space and then compute the similarity sim(U, r_{tgt}). The output of each neural network is the following:

Zᵤ=ReLU(U×w+b)

Zᵣ_{_{tgt}}=ReLU(r_{tgt}×w+b)

sim(U,r_{tgt})=dist(Zᵤ,Zᵣ_{_{tgt}})

where ReLU is an activation function defined as the positive part of its argument relu(x)=max(0, x⁺), dist( )represents the distance measurement such as Euclidean distance, and w and b are the parameters that need to be trained. Therefore, we predict the target trip \tilde{r}_{tgt} through choosing the highest similarity score among all candidates.

We explored the deployment of the proposed model on trip pattern prediction task that predicts which location user will visit at certain time given his/her trip history. The dataset includes user location tracking including driving. Raw features include, for example, the following: <user ID, location_gps_grid_ID, timestamp), 100 users, 778 locations through a 200 m×200 m grid by map segmentation, over a 20-week period.

We assume we have user trip records for week w that include the following:

I_{w}=

{(visit location i₀ at time t₀), . . . , (visit location i_{T} at time t_{T})}, t ∈w, where we aim to predict I_{w+i}. We use the first 19 weeks as a set of data for training, where the data contains both location i and timestamp t information for the visit, and use the last week as the test set.

We applied I-best matching accuracy that is widely used in recommendation systems to measure the performance. Meanwhile, the parameter number and prediction time were reported to indicate the scalability. The following table shows a performance comparison with aforementioned prior art model “ATRank” and different kernel of proposed layers regarding the prediction accuracy and prediction time.

| | | | Prediction | Trainable | | Processing | Processing |
|---|---|---|---|---|---|---|---|
| | | | accuracy | Parameters | | time | Time |
| | | Prediction | (Top 1 | (compared to | Hardware | (per | (per |
| Index | Model | target size | Matching) | baseline model) | configuration | week) | target) |
| 1 | ATRank * | 100 | 0.59 | 239,200 | CPU: Intel | 13.22 sec | 6.7 ms |
| | (Baseline) | users, | | | Xeon E5-2690 | | |
| 2 | ATRank * + | 1 week, | 0.70 | 221,156 | GPU: Tesla | 1.08 sec | 6.7 ms |
| | Proposed | 2,468 | | (−8%) | V100-PCIE- | | |
| | Contrext | targets | | | 16 GB; | | |
| | Modeling | | | | RAM: 112 GB; | | |
| | Layer | | | | System: Linux | | |
| 3 | Proposed | | 0.72 | 158,256 | Ubuntu | 1.79 sec | 0.9 sec |
| | Model | | (+22%) | (−33%) | | (x7.4) | (x7.4) |

* represents the model requiring sequential input that causes a heavy computational cost (such as collecting history data [t − Δt, t] based on the target timestamp t).

The results show that the algorithmic framework and model according to the present invention achieve better prediction performance with outstanding operation/computation efficiency.

In another exemplary embodiment of the present invention, a non-transitory computer-readable medium is encoded with a computer program that performs the above-described method. Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium from which a computer can read.

The present invention provides a number of significant advantages over conventional systems and methods. As described above, the present invention provides a context-aware learning framework for predicted destination. We are able to leverage context information to model user trip patterns. Not only the final prediction retains an improved performance, but also the intermedia output such as object embedding and user embedding can be the critical features for other downstream tasks, e.g., segmentation.

The algorithmic framework according to the present invention has low complexity. Instead of jointly modeling history trips and a target trip, we are able to separate them, pre-calculate and store the user embedding offline, and estimate the target trip online only. This dramatically decreases the complexity as online target trip calculation is much cheaper than user embedding that has to go through the all historical trips in the database.

The present invention also provides rich semantic modeling. By using embeddings, we expand the capabilities of previous Natural Language Processing (NLP) methods by creating contextual representations based on the surrounding context which leads to richer semantic models. Further, the algorithm according to the present invention outperforms conventional models in both higher prediction performance and much lower computation cost.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for predicting a trip destination of a user comprising:
receiving historical behaviors and a target behavior of the user from a feature processing layer;
embedding the received historical behaviors and the target behavior with features including a time and a location to produce a context modeling layer;
embedding the context modeling layer to produce a user modeling layer; and
predicting the trip destination based on historical trip data and target trip data in the user modeling layer.

2. The method according to claim 1, further comprising:
comparing an actual destination of the user to the predicted trip destination to determine an error.

3. The method according to claim 2, further comprising:
updating the historical behaviors based on the actual destination.

4. The method according to claim 3, further comprising:
repeating the method with the updated historical behaviors.

5. The method according to claim 1, further comprising:
outputting the predicted trip destination to a vehicle of the user.

6. The method according to claim 1, wherein the time includes a day of the week and a time of day.

7. The method according to claim 1, further comprising providing a time-to-leave that reminds the user to leave at a particular time due to real time traffic.

8. The method according to claim 1, further comprising sending a reminder to the user to precondition a vehicle of the user before a trip to the trip destination.

9. The method according to claim 1, further comprising controlling a vehicle to automatically precondition the vehicle by heating or cooling an interior of the vehicle before a trip to the trip destination.

10. A non-transitory computer-readable medium storing a program that, when executed by a processor, causes the processor to perform a method comprising:
receiving historical behaviors and a target behavior of the user from a feature processing layer;
embedding the received historical behaviors and the target behavior with features including a time and a location to produce a context modeling layer;
embedding the context modeling layer to produce a user modeling layer; and
predicting the trip destination based on historical trip data and target trip data in the user modeling layer.

11. The non-transitory computer-readable medium according to claim 10, wherein the program causes the processor to compare an actual destination of the user to the predicted trip destination to determine an error.

12. The non-transitory computer-readable medium according to claim 10, wherein the program causes the processor to update the historical behaviors based on the actual destination.

13. The non-transitory computer-readable medium according to claim 12, wherein the program causes the processor to repeat the method with the updated historical behaviors.

14. The non-transitory computer-readable medium according to claim 10, wherein the program causes the processor to output the predicted trip destination to a vehicle of the user.

15. The non-transitory computer-readable medium according to claim 10, wherein the time includes a day of the week and a time of day.

16. The non-transitory computer-readable medium according to claim 10, wherein the program causes the processor to provide a time-to-leave that reminds the user to leave at a particular time due to real time traffic.

17. The non-transitory computer-readable medium according to claim 10, wherein the program causes the processor to send a reminder to the user to precondition a vehicle of the user by heating or cooling an interior of the vehicle before a trip to the trip destination.

18. The non-transitory computer-readable medium according to claim 10, wherein the program causes the processor to control a vehicle to automatically precondition the vehicle by heating or cooling an interior of the vehicle before a trip to the trip destination.
